(19) United States
(12) Patent Application Publication
(10) Pub. No.: US 2013/0219632 A1
(43) Pub. Date: Aug. 29, 2013

(54) PROCESS FOR PRODUCING A COLORANT

(71) Applicant: Henkel AG & Co. KGaA, (US)

(72) Inventors: Frank Janssen, Koln (DE); Juergen Schoepgens, Schwalmtal (DE); Jens Hainmueller, Duesseldorf (DE); Andrea Borntrager, Erkrath (DE)

(73) Assignee: Henkel AG & Co. KGaA, Duesseldorf (DE)

(21) Appl. No.: 13/859,924

(22) Filed: Apr. 10, 2013

Related U.S. Application Data
(63) Continuation of application No. PCT/EP2011/058794, filed on May 30, 2011.

(30) Foreign Application Priority Data
Oct. 20, 2010 (DE) 10 2010 042 662.8

(51) Int. Cl. B67D 7/74

(52) U.S. Cl. CPC B67D 7/74
USPC 8/407; 141/2

(57) ABSTRACT

Methods for producing a coloring agent for keratin fibers from a first composition A, a second composition B and a third composition C, in which the first composition A is directed from a container A, by means of a filling device, via an inlet, to a second container B containing the second composition B and/or, to a third container C containing the third composition C, wherein composition A is introduced into container B and/or into container C, and container B and/or container C, through the introduction of composition A and/or the influence of the filling device, forms at least one outlet, from which a mixture of compositions A and B and/or a mixture of compositions A and C emerges, are suitable for producing homogeneous coloring agents for keratin fibers with a viscosity that is suitable for the treatment of hair.

### FIELD OF THE INVENTION

The present invention generally relates to methods for producing a coloring agent for keratin fibers, and more particularly relates to methods for producing a coloring agent for keratin fibers from a first composition, a second composition, and a third composition.

### BACKGROUND OF THE INVENTION

Presently, human hair is treated with hair cosmetics preparations in many different ways. These include washing the hair with shampoo, care and regeneration with rinses and masks, and bleaching, coloring and shaping the hair with dyes, tints, permanent wave agents and styling preparations. Agents for changing or shading the color of the head hair have a prominent role to play here.

For temporary colors, coloring or tinting agents are conventionally used which contain substantive dyes as the coloring component. These are dye molecules which attach directly to the hair and require no oxidative process to develop the color. These dyes include henna, for example, which has been known since ancient times for coloring the body and hair. These colors are generally significantly more sensitive to shampooing than oxidative colors, such that an often undesired shift in shade or even a visible “decolorization” then occurs much more quickly.

For lasting, intense colors with corresponding fastness properties, oxidation coloring agents are used. Such coloring agents conventionally contain oxidation dye precursors known as developer components and coupler components. Under the influence of oxidizing agents or of atmospheric oxygen, the developer components form the actual dyes with one another or by coupling with one or more coupler components. Oxidation coloring agents have the characterizing feature of producing outstanding, long-lasting coloring results. A mixture of quite a large number of oxidation dye precursors usually has to be used in order to achieve natural-looking colors.

Furthermore, substantive dyes or care agents such as plant extracts are added to the oxidation coloring agents to shade the hair color obtained and to care for the treated hair.

These coloring agents, in particular oxidative coloring agents or bleaching powders, are generally produced by manually mixing together prepared active agent compositions, for example two oxidative coloring agents or two bleaching agents. Manual mixing is, however, time-consuming and labor-intensive. Thus the constituents have to be weighed out, for example, prior to being mixed together. Furthermore, homogenizing the mixture by manually mixing the active agents is a time-consuming process. In addition, if solid active agent compositions are processed, the user is exposed to any dusts that may be formed.

Against this background, the US Patent Publication No. 2005/0169871 A1 describes a method for preparing active agent mixtures for the treatment of hair in which a liquid is passed through a polymer-containing preparation at elevated temperature and at a pressure above 3 bar. Although this method is suitable for preparing a mixture of the active agents that are used, the mixture obtained still leaves room for improvement, for use in hair coloring in particular, because of its inhomogeneity and inadequate viscosity.

It has now been found that the aforementioned disadvantages of conventional mixing methods can be eliminated by a method for producing a coloring agent for keratin fibers from a first composition A, a second composition B and a third composition C, in which

the first composition A is directed from a container A

by means of a filling device

via an inlet

to a second container B containing the second composition B and/or

to a third container C containing the third composition C,

wherein composition A is introduced into container B and/or into container C, and container B and/or container C, through the introduction of composition A and/or the influence of the filling device, forms at least one outlet, from which a mixture of compositions A and B and/or a mixture of compositions A and C emerges.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method for producing a coloring agent for keratin fibers from a first composition A, a second composition B and a third composition C, in which the first composition A is directed from a container A by means of a filling device via an inlet to a second container B containing the second composition B and/or to a third container C containing the third composition C, wherein composition A is introduced into container B and/or into container C, and container B and/or container C, through the introduction of composition A and/or the influence of the filling device, forms at least one outlet, from which a mixture of compositions A and B and/or a mixture of compositions A and C emerges.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In the context of the method according to the invention three mutually different compositions A, B and C are mixed together to form a coloring agent for keratin fibers.

The feeding of composition A takes place from a container A. This container A is preferably structured as a storage container and preferably encompasses several times the amount of composition A that is necessary to perform a single mixing process. In other words, in a preferred variant of the method, a partial amount, a, of composition A contained in container A is introduced into container B, with a residual amount of composition A contained in container A remaining in container A until the end of the mixing process and this residual amount corresponding to at least twice, preferably at least four times, and in particular, at least eight times the amount of the partial amount a.

In a further preferred embodiment, container A has two or more chambers (e.g. A1 and A2), in which mutually different compositions (e.g. A1 and A2) are present separately from one another. The device used to perform the method according to the invention is structured in such a way that the user chooses between the two or more chambers and alternatively, a composition, A1, for example, is used in a first mixing process and a composition, A2, in a subsequent mixing process.

As an alternative to the multi-chamber design of container A described above, the device for performing the method according to the invention can also provide two or more separate containers for holding different compositions A.

The introduction of composition A from container A into container B and/or into container C preferably takes place by means of a line system connecting to container A. At the end of this line system is the filling device provided to introduce composition A into container B and/or into container C. To shorten the duration of the process and to improve the results of the process, in particular the quality of the mix, composition A is preferably introduced into container B and/or into container C at a pressure above 1.1 bar, preferably above 2.0 bar, preferably above 5.0 bar and in particular between 10 and 20 bar.

During the course of the method, composition A is introduced into container B and/or into container C, from which subsequently a mixture of compositions A and B and/or a mixture of compositions A and C emerges.

Containers B and C that are used for this purpose are preferably secured in the device used to perform the method according to the invention by means of a screw-type, adhesive, latching, snap-action or clamping mechanism.

Containers B and C are preferably designed in the form of a closed capsule. In a preferred variant of the method according to the invention, this closed capsule is opened by means of the line system carrying composition A. The opening operation preferably takes place by penetration of the container wall of container B and/or container C, for example by means of the filling device located at the end of the line system. This filling device can be shaped in the form of a spike, for example. Following the piercing of the container wall, composition A is then introduced into container B and/or into container C.

In a preferred embodiment of the method according to the invention, at least one outlet is formed by the introduction of composition A into container B and/or into container C. The outlet can be formed by the rising pressure in container B and/or C, for example. Alternatively, however, the outlet can also be formed by the influence of the filling device, for example by the filling device piercing the container wall of container B and/or C in two places or by the pressure rising in the container due to the penetration of a container wall causing the outlet to form.

Methods according to the invention, in which container B and/or container C, through the introduction of composition A and/or the influence of the filling device, forms at least one outlet, from which the coloring agent for keratin fibers emerges from container B and/or C as a mixture of compositions A and B and/or A and C, allow a simple and effective mixing of the compositions used and are preferred for that reason.

The formation of the outlet in the container wall of container B, in particular the exact location at which this outlet is formed, is preferably controlled through the specific design of container B and/or container C.

In a first preferred embodiment, container B and/or container C has a break line along which the outlet forms through the introduction of composition A and/or the influence of the filling device.

In a second preferred embodiment, container B and/or container C has a membrane, which through the introduction of composition A and/or the influence of the filling device is pressed against a spike to form the outlet. The membrane is preferably a constituent of the container wall of container B and/or container C. The penetration of the membrane by the spike causes the outlet to form. The spike can be positioned either inside container B and/or C or outside container B and/or C. If the spike is positioned inside container B and/or C, the container wall of container B and/or C is opened from the inside to the outside. If the spike is located outside container B and/or outside container C, the spike presses the container wall from the outside to the inside. The container wall of container B and/or container C preferably has a break line in the area of action of the spike, through which, for example, the size of the outlet can be influenced.

To improve the mixing action, composition A and/or the mixture of compositions A and B and/or A and C preferably passes through a static mixer during the course of the method. This static mixer can be positioned inside the aforementioned line system, for example, but it is preferably located immediately adjacent to the outlet of container B and/or container C, for example inside container B and/or C or outside the outlet of the corresponding container. In this last case, the static mixer can be formed as an integral constituent of container B and/or container C. Alternatively, the static mixer is a constituent of the device used to perform the method according to the invention and is, for example, associated with the screw-type, adhesive, latching, snap-action or clamping mechanism used to secure container B and/or C.

Through the arrangement of a static mixer inside container B and/or container C, a particularly homogeneous mix of the compositions that are used is achieved, for which reason methods according to the invention in which container B and/or container C has a static mixing element in its interior are preferably used.

During the course of the method, composition B contained in container B and/or composition C contained in container C is discharged through the outlet from container B and/or container C by the introduced composition A. The discharge preferably occurs substantially completely. In other words, at least 80 weight percent (wt. %), preferably at least 90 wt. %, particularly preferably at least 95 wt. % and in particular at least 98 wt. % of composition B and/or composition C is discharged from the corresponding container.

The following three alternative process control options are suitable in particular for the final combining and mixing of compositions A, B and C.

In a first preferred variant of the method according to the invention, composition A is introduced into container B and into container C, and container B and container C, through the introduction of composition A and/or the influence of the filling device, form at least one outlet, from which a mixture of compositions A and B and/or a mixture of compositions A and C emerges, and the mixture of compositions A and B and the mixture of compositions A and C are subsequently combined to form a coloring agent for keratin fibers.

In a second preferred variant of the method according to the invention, composition A is introduced into container B, and container B, through the introduction of composition A and/or the influence of the filling device, forms at least one outlet, from which a mixture of compositions A and B emerges, which mixture is subsequently introduced into container C, containing composition C, with formation of the coloring agent for keratin fibers.

In a third preferred variant of the method according to the invention, composition A is introduced into container C, and container C, through the introduction of composition A and/or the influence of the filling device, forms at least one outlet, from which a mixture of compositions A and C emerges, which mixture is subsequently introduced into container B, containing composition B, with formation of the coloring agent for keratin fibers.

Each of these three aforementioned variants, but in particular the last two alternative methods, are suitable for the simple production of a homogeneous coloring agent for keratin fibers.

A number of specific approaches are, in turn, preferred in order to implement these last two preferred variants of the method, in which a first mixture of compositions A and B or A and C is introduced into a further container containing composition C or B.

In a first preferred embodiment of the method according to the invention, containers B and C are connected to each other, for example, by means of a screw-type, adhesive, latching, snap-action or clamping mechanism (coupled containers). The two containers can be connected directly or by means of an adapter. Depending on the variant of the method, container B can be attached above or below container C in the direction of flow of composition A.

In a second preferred embodiment, containers B and C are constituents of a multi-chamber container, for example, a two-chamber container.

In the context of the method according to the invention, composition A preferably flows through the coupled containers or the two-chamber or multi-chamber container, inside which compositions B and C are contained. To this end, composition A enters at an inlet in the coupled containers or the multi-chamber container and the coloring agent for keratin fibers emerges at an outlet from these coupled containers or the multi-chamber container as a mixture of compositions A, B and C.

In a likewise preferred alternative variant of the method, composition A flows through only one of the chambers of the coupled containers or of the two-chamber or multi-chamber container, i.e., container B or C, wherein subsequently the mixture of compositions A and B or A and C that is formed collects in the remaining third chamber, i.e., chamber C or B, and mixes with composition C or B therein.

The volume ratio of compositions A and B or compositions A and C used in the mixing method is preferably 10:1 to 1:1 and in particular 6:1 to 2:1. The absolute volume of composition A that is used is preferably between 5 and 500 milliliters (ml), preferably between 10 and 400 ml and in particular between 20 and 300 ml.

The weight ratio of compositions A and B or compositions A and C used in the method is preferably between 1:1 and 20:1, preferably between 2:1 and 10:1 and in particular, between 3:1 and 8:1.

In the course of the mixing process, compositions A and B or A and C are preferably not heated by means of an external heat source. The temperature of composition A should preferably be less than 35° C., preferably less than 30° C. and in particular, less than 25° C. On emerging from container B or from container C the temperature of the coloring agent for keratin fibers should likewise preferably be less than 35° C., preferably less than 30° C. and in particular, less than 25° C.

The coloring agent for keratin fibers obtained as the end product of the process preferably has a pH of between 5 and 12, preferably between 7.5 and 11.

The method according to the invention is suitable in particular for producing coloring agents for keratin fibers having a viscosity above 20,000 megaPascal·seconds (mPa·s) (Brookfield viscometer, spindle 5, 4 revolutions per minute (rpm)), preferably between 20,000 and 100,000 mPa·s (Brookfield viscometer, spindle 5, 4 rpm) and in particular between 25,000 and 40,000 mPa·s (Brookfield viscometer, spindle 5, 4 rpm). The production of coloring agents having a corresponding viscosity is therefore preferred according to the invention.

In addition to the aforementioned mandatory constituents, compositions A, B and C that are mixed with one another in the method according to the invention can moreover contain a large number of hair color-changing active agents. Thus, for example

two different oxidation dye precursors and an oxidizing agent,

two different substantive dyes and an oxidizing agent,

an oxidation dye precursor, a substantive dye and an oxidizing agent,

two different strong oxidizing agents and an oxidation dye precursor,

two different strong oxidizing agents and a substantive dye,

an oxidation dye precursor, a care agent and an oxidizing agent,

a substantive dye, a care agent and an oxidizing agent,

can be mixed together in the method according to the invention to form a coloring agent for keratin fibers.

Preferred methods for producing a coloring agent for keratin fibers have the characterizing feature that composition A contains at least one oxidizing agent and/or composition B contains at least one coloring agent from the group of oxidation dye precursors and substantive dyes.

Composition A is preferably free-flowing and in the form of a liquid, gel or paste. Particularly preferred liquid compositions A contain at least 30 wt. %, preferably at least 40 wt. % and in particular at least 50 wt. % of water. The proportion by weight of water is preferably between 30 and 98 wt. %, more preferably between 40 and 96 wt. % and in particular between 50 and 94 wt. %, relative in each case to the total weight of composition A.

In a preferred variant of the method, composition A contains at least one oxidizing agent, preferably 0.5 to 50 wt. %, preferably 1.0 to 20 wt. %, particularly preferably 2.5 to 16 wt. % and in particular 5.0 to 14 wt. % of hydrogen peroxide (calculated as 100% H₂O₂), relative in each case to the total weight of composition A.

Composition B can be present in free-flowing form, for example as a liquid, gel or paste, but also as a solid, in particular as a powder or pressed powder. In terms of the duration of the process and to improve the results of the process, in particular the quality of the mix, however, free-flowing as opposed to solid compositions B have proved to be advantageous.

Composition C can be present in free-flowing form, for example as a liquid, gel or paste, but also as a solid, in particular as a powder or pressed powder. In terms of the duration of the process and to improve the results of the process, in particular the quality of the mix, however, free-flowing as opposed to solid compositions C have proved to be advantageous.

The methods according to the invention serve the simple and efficient production of coloring agents for keratinic fibers. Accordingly, corresponding agents by nature contain suitable coloring or decolorizing active substances. Preferred variants of the method have the characterizing feature that composition B contains at least one oxidation dye precursor or at least one substantive dye.

The methods according to the invention furthermore serve the technically simplified shading of a coloring result and/or the care of keratinic fibers treated with coloring agents. For that reason, preferred variants of the method have the characterizing feature that composition C contains at least one oxidation dye precursor or at least one substantive dye or at least one care agent.

In a first preferred embodiment, composition B and/or composition C contains at least one oxidative coloring agent (oxidation dye precursor).

According to the invention oxidative coloring agents are understood to be hair color-changing agents that bring about a lasting coloring of the fibers through the oxidation of oxidation dye precursors.

The present invention is subject to no restrictions in terms of the dye precursors that can be used in compositions B and C according to the invention. Compositions B, according to the invention, can contain, as dye precursors, oxidation dye precursors of the developer and/or coupler type and precursors of nature-analogous dyes, such as indole and indoline derivatives, as well as mixtures of representatives of these groups.

In the context of a first preferred embodiment of the present invention, compositions B and/or C that are used according to the invention contain at least one oxidation dye precursor of the developer and/or coupler type.

It can be preferable according to the invention to use a p-phenylenediamine derivative or one of its physiologically acceptable salts as the developer component.

Particularly preferred p-phenylenediamines are selected from p-phenylenediamine, p-toluoylenediamine, 2-chloro-p-phenylenediamine, N,N-bis-(2-hydroxyethyl)-p-phenylenediamine and N-phenyl-p-phenylenediamine, 2-(2-hydroxyethyl)-p-phenylenediamine, N-(4-amino-3-methylphenyl)-N-[3-(1H-imidazol-1-yl)propyl]amine and their physiologically acceptable salts.

It can furthermore be preferable according to the invention to use as the developer component compounds containing at least two aromatic nuclei which are substituted with amino and/or hydroxyl groups.

Preferred binuclear components are in particular: N,N-bis-(2-hydroxyethyl)-N,N′-bis-(4′-aminophenyl)-1,3-diaminopropan-2-ol and bis-(2-hydroxy-5-aminophenyl)methane and physiologically acceptable salts thereof.

It can furthermore be preferable according to the invention to use a p-aminophenol derivative or one of its physiologically acceptable salts as the developer component.

Preferred p-aminophenols are in particular p-aminophenol, N-methyl-p-aminophenol and 4-amino-3-methylphenol and physiologically acceptable salts thereof.

The developer component can moreover be selected from o-aminophenol and its derivatives, such as for example 2-amino-5-methylphenol and physiologically acceptable salts thereof.

The developer component can furthermore be selected from heterocyclic developer components, such as for example the pyridine, pyrimidine, pyrazole, pyrazolopyrimidine derivatives and their physiologically acceptable salts.

Preferred pyrimidine derivatives are in particular 2,4,5,6-tetraminopyrimidine and 4-hydroxy-2,5,6-triaminopyrimidine and physiologically acceptable salts thereof.

A preferred pyrazole derivative is 4,5-diamino-1-(2-hydroxyethyl)pyrazole and physiologically acceptable salts thereof.

In a further preferred embodiment compositions B and/or C contain at least one coupler component.

m-Phenylenediamine derivatives, naphthols, resorcinol and resorcinol derivatives, pyrazolones and m-aminophenol derivatives are generally used as coupler components. In particular, 1-naphthol, 1,5- and 2,7-dihydroxynaphthalene, 1-acetoxy-2-methoxynaphthalene, resorcinol, 4-chlororesorcinol and 2-amino-3-hydroxypyridine and physiologically acceptable salts thereof are suitable as coupler substances.

Coupler components that are preferred according to the invention are
(A) m-aminophenol and derivatives thereof such as for example 5-amino-2-methylphenol, 3-amino-2-chloro-6-methylphenol, 5-amino-4-chloro-2-methylphenol, 5-(2′-hydroxyethyl)amino-2-methylphenol and 2,4-dichloro-3-aminophenol,
(B) o-aminophenol and derivatives thereof, for example 2-amino-5-ethylphenol,
(C) m-diaminobenzene and derivatives thereof such as for example 2,4-diaminophenoxyethanol, 1,3-bis-(2′,4′-diaminophenoxy)propane, 1-methoxy-2-amino-4-(2′-hydroxyethylamino)benzene, 2,6-bis-(2′-hydroxyethyl amino)-1-methylbenzene, 2-({3-[(2-hydroxyethyl)amino]-4-methoxy-5-methylphenyl}amino)ethanol and 2-({3-[(2-hydroxyethyl)amino]-2-methoxy-5-methylphenyl}amino)ethanol,
(D) o-diaminobenzene and derivatives thereof,
(E) di- or trihydroxybenzene derivatives such as for example 2-methylresorcinol and 1,2,4-trihydroxybenzene,
(F) pyridine derivatives such as for example 3-amino-2-methylamino-6-methoxypyridine, 2,6-diaminopyridine, 2,6-dihydroxy-3,4-dimethylpyridine, 2-amino-3-hydroxypyridine and 3,5-diamino-2,6-dimethoxypyridine,
(G) naphthalene derivatives such as for example 1-naphthol and 2-methyl-1-naphthol,
(H) morpholine derivatives such as for example 6-hydroxybenzomorpholine,
(I) quinoxaline derivatives,
(J) pyrazole derivatives such as for example l-phenyl-3-methylpyrazol-5-one,
(K) indole derivatives such as for example 6-hydroxyindole,
(L) pyrimidine derivatives or
(M) methylenedioxybenzene derivatives such as for example 1-(2′-hydroxyethyl)-amino-3,4-methylenedioxybenzene
   and physiologically acceptable salts thereof.

Coupler components that are particularly preferred according to the invention are 1-naphthol, 1,5- and 2,7-dihydroxynaphthalene, 5-amino-2-methylphenol, 2-amino-3-hydroxypyridine, resorcinol, 4-chlororesorcinol, 2-methylresorcinol and 2,6-dihydroxy-3,4-dimethylpyridine and physiologically acceptable salts thereof.

Compositions B and/or C that are used according to the invention contain both the developer components and the coupler components preferably in an amount from 0.005 to 20 wt. %, preferably 0.1 to 5 wt. %, relative in each case to the total weight of composition B or C. Developer components and coupler components are generally used in approximately molar amounts to one another. Even if the molar use has proved convenient, a certain excess of individual oxidation dye precursors is not disadvantageous, such that developer components and coupler components can be included in a molar ratio of 1:0.5 to 1:3, in particular 1:1 to 1:2.

In a further embodiment of the present invention compositions B and/or C contain at least one precursor of a nature-analogous dye as the oxidation dye precursor. Indoles and indolines containing at least one hydroxyl or amino group, preferably as a substituent on the six-membered ring, are preferably used as dye precursors of nature-analogous dyes.

Particularly preferred derivatives of indoline are 5,6-dihydroxyindoline and 2,3-dioxoindoline (isatine) and physiologically acceptable salts thereof. A particularly preferred derivative of indole is 5,6-dihydroxyindole and physiologically acceptable salts thereof.

Compositions B and/or C according to the invention contain the indole or indoline derivatives preferably in an amount from 0.05 to 10 wt. %, preferably 0.2 to 5 wt. %, relative in each case to their total weight.

In addition to the oxidation dye precursors or as an alternative to these coloring agents, compositions B can also contain substantive dyes. In a further preferred embodiment compositions B and/or C according to the invention contain at least one substantive dye. Substantive dyes can be divided into anionic, cationic and non-ionic substantive dyes. The substantive dyes are preferably selected from nitrophenylenediamines, nitroaminophenols, azo dyes, anthraquinones or indophenols and physiologically acceptable salts thereof.

Suitable in particular as anionic substantive dyes are 2,4-dinitro-1-naphthol-7-sulfonic acid disodium salt (C.l. 10316; Acid Yellow 1; Food Yellow No. 1), 2-(indane-1,3-dion-2-yl) quinoline-x,x-sulfonic acid (mixture of mono- and disulfonic acid) (C.l. 47005; D&C Yellow No. 10; Food Yellow No. 13; Acid Yellow 3, Yellow 10), 5-hydroxy-1-(4-sulfophenyl)-4-[(4-sulfophenyl)azo]pyrazole-3-carboxylic acid trisodium salt (C.l. 19140; Food Yellow No. 4; Acid Yellow 23), 3-[(4-phenylamino)phenyl]azobenzenesulfonic acid sodium salt (C.l. 13065; Ki406; Acid Yellow 36), 4-[(2-hydroxynaphth-1-yl)azo]benzenesulfonic acid sodium salt (C.l. 15510; Acid Orange 7), 6-hydroxy-5-[(4-sulfonaphth-1-yl)azo]-2,4-naphthalene disulfonic acid trisodium salt (C.l. 16255; Ponceau 4R; Acid Red 18), 8-amino-1-hydroxy-2-(phenylazo)-3,6-naphthalene disulfonic acid disodium salt (C.l. 17200; Acid Red 33; Red 33), N-[6-(diethylamino)-9-(2,4-disulfophenyl)-3H-xanthen-3-ylidene]-N-ethyl ethaneammonium hydroxide, internal salt, sodium salt (C.l. 45100; Acid Red 52), 2′,4′,5′,7′-tetrabromo-4,5,6,7-tetrachloro-3′,6′-dihydroxyspiro[isobenzofurane-1(3H), 9′[9H]xanthen]-3-one disodium salt (C.l. 45410; Acid Red 92), 3-hydroxy-4-[(4-methyl-2-sulfonephenyl)azo]-2-naphthalene carboxylic acid calcium salt (C.l. 15850:1; Pigment Red 57:1), 1,4-bis[(2-sulfo-4-methylphenyl)amino]-9,10-anthraquinone disodium salt (C.l. 61570; Acid Green 25), bis[4-(dimethylamino)phenyl]-(3,7-disulfo-2-hydroxynaphth-1-yl)carbenium internal salt, sodium salt (C.l. 44090; Food Green No. 4; Acid Green 50), N-[4-[(2,4-disulfophenyl)[4-[ethyl(phenylmethyl)amino)phenyl]methylene]-2,5-cyclohexadien-1-ylidene]-N-ethylbenzenemethanaminium hydroxide, internal salt, sodium salt (C.l. 42080; Acid Blue 7), (2-sulfophenyl)di[4-(ethyl((4-sulfophenyl)methyl)amino)phenyl]carbenium disodium salt betaine (C.l. 42090; Acid Blue 9; FD&C Blue No. 1), 1-amino-4-(cyclohexylamino)-9,10-anthraquinone-2-sulfonic acid sodium salt (C.l. 62045; Acid Blue 62), 1-hydroxy-4-[(4-methyl-2-sulfophenyl)amino]-9,10-anthraquinone sodium salt (C.l. 60730; D&C Violet No. 2; Acid Violet 43), 5-amino-4-hydroxy-6-[(4-nitrophenyl)-azo]-3-(phenylazo)-2,7-naphthalene disulfonic acid disodium salt (C.l. 20470; Acid Black 1), 3-hydroxy-4-[(2-hydroxynaphth-1-yl)azo]-7-nitro-1-naphthalene sulfonic acid chromium complex (3:2) (C.l. 15711; Acid Black 52), 3′,3″,4,5,5′,5″,6,7-octabromophenol sulfonephthalein (tetrabromophenol blue).

Preferred anionic substantive dyes are the compounds known under the international names or trade names Acid Yellow 1, Yellow 10, Acid Yellow 23, Acid Yellow 36, Acid Orange 7, Acid Red 33, Acid Red 52, Pigment Red 57:1, Acid Blue 7, Acid Green 50, Acid Violet 43, Acid Black 1 and Acid Black 52.

Suitable in particular as cationic substantive dyes are di[4-(diethylamino)phenyl][4-(ethylamino)naphthyl]carbenium chloride (C.l. 42595; Basic Blue 7), di[4-(dimethylamino)phenyl][4-(phenylamino)naphthyl]carbenium chloride (C.l. 44045; Basic Blue 26), 8-amino-2-bromo-5-hydroxy-4-imino-6-[(3-(trimethylammonio)phenyl)amino]-1(4H)-naphthalenone chloride (C.l. 56059; Basic Blue No. 99), tri(4-amino-3-methylphenyl)carbenium chloride (C.l. 42520; Basic Violet 2), di(4-aminophenyl)(4-amino-3-methylphenyl)carbenium chloride (C.l. 42510 Basic Violet 14), 1-[(4-aminophenyl)azo]-7-(trimethylammonio)-2-naphthol chloride (C.l. 12250; Basic Brown 16), 1-[(4-amino-3-nitrophenyl)azo]-7-(trimethylammonio)-2-naphthol chloride (C.l. 12251; Basic Brown 17), 3-[(4-amino-2,5-dimethoxyphenyl)azo]-N,N,N-trimethylbenzeneaminium chloride (C.l. 12605, Basic Orange 69), 2-[((4-dimethylamino)phenyl)azo]-1,3-dimethyl-1H-imidazolium chloride (Basic Red 51), 2-hydroxy-1-[(2-methoxyphenyl)azo]-7-(trimethylammonio)naphthalene chloride (C.l. 12245; Basic Red 76), 2-[4-aminophenyl]azo]-1,3-dimethyl-1H-imidazolium chloride (Basic Orange 31), 3-methyl-1-phenyl-4-[(3-(trimethyl ammonio)phenyl)azo]pyrazol-5-one chloride (C.l. 12719; Basic Yellow 57), 1-methyl-4-((methylphenylhydrazono)methyl)pyridinium methylsulfate (Basic Yellow 87), 1-(2-morpholiniumpropylamino)-4-hydroxy-9,10-anthraquinone methylsulfate, 4-formyl-1-methylquinolonium-p-toluenesulfonate and substantive dyes containing a heterocyclic compound having at least one quaternary nitrogen atom.

Non-ionic nitro and quinone dyes and neutral azo dyes in particular are suitable as non-ionic substantive dyes.

Suitable blue nitro dyes are in particular 1,4-bis[(2-hydroxyethyl)amino]-2-nitrobenzene (HC Violet BS), 1-(2-hydroxyethyl)amino-2-nitro-4-[di(2-hydroxyethyl)amino]benzene (HC Blue 2), 4-[di(2-hydroxyethyl)amino]-1-[(2-methoxyethyl)amino]-2-nitrobenzene (HC Blue 11), 4-[ethyl-(2-hydroxyethyl)-amino]-1-[(2-hydroxyethyl)amino]-2-nitrobenzene hydrochloride (HC Blue 12), 1-(2-hydroxyethyl)amino-2-nitro-4-N-ethyl-N-(2-hydroxyethyl)aminobenzene (HC Blue 15), 1-amino-3-methyl-4-[(2-hydroxyethyl)amino]-6-nitrobenzene (HC Violet 1), 1-(3-hydroxypropylamino)-4-[di(2-hydroxyethyl)amino]-2-nitrobenzene (HC Violet 2).

Suitable red nitro dyes are in particular 1-amino-4-[(2-hydroxyethyl)amino]-2-nitrobenzene (HC Red 7), 2-amino-4,6-dinitrophenol (picramic acid) and salts thereof, 1,4-diamino-2-nitrobenzene (C.l. 76070), 4-amino-2-nitrodiphenylamine (HC Red 1), 1-amino-4-[di(2-hydroxyethyl)amino]-2-nitrobenzene hydrochloride (HC Red 13), 1-amino-4-[(2-hydroxyethyl)amino]-5-chloro-2-nitrobenzene, 4-amino-1-[(2-hydroxyethyl)amino]-2-nitrobenzene (HC Red 3), 4-[(2-hydroxyethyl)-amino]-3-nitrotoluene, 4-amino-3-nitrophenol, 4-[(2-hydroxyethyl)amino]-3-nitrophenol, 4-[(2-nitrophenyl)amino]phenol (FTC Orange 1), 1-[(2-aminoethyl)amino]-4-(2-hydroxyethoxy)-2-nitrobenzene (HC Orange 2), 1-amino-5-chloro-4-[(2,3-dihydroxypropyl)amino]-2-nitrobenzene (HC Red 10), 5-chloro-1,4-[di(2,3-dihydroxypropyl)amino]-2-nitrobenzene (HC Red 11), 2-[(2-hydroxyethyl)amino]-4,6-dinitrophenol and salts thereof, 4-ethylamino-3-nitrobenzoic acid, 2-[(4-amino-2-nitrophenyl)amino]benzoic acid, 2-chloro-6-ethylamino-4-nitrophenol, 2-amino-6-chloro-4-nitrophenol, 4-[(3-hydroxypropyl)amino]-3-nitrophenol (HC Red BN), 1,2,3,4-tetrahydro-6-nitroquinoxaline, 6-hydroxy-5-((2-methoxy-5-methyl-4-sulfophenyl)azo)-2-naphthalenesulfonic acid (Curry Red).

Suitable yellow nitro dyes are in particular 1,2-diamino-4-nitrobenzene (C.l. 76020), 1-[(2-hydroxyethyl)amino]-2-nitrobenzene (HC Yellow 2), 1-(2-hydroxyethoxy)-2-[(2-hydroxyethyl)amino]-5-nitrobenzene (HC Yellow 4), 1-amino-2-[(2-hydroxyethyl)amino]-5-nitrobenzene (HC Yellow 5), 4-[(2,3-dihydroxypropyl)amino]-3-nitro-1-trifluoromethylbenzene (HC Yellow 6), 2-[(2-hydroxyethyl)amino]-1-methoxy-5-nitrobenzene, 2-amino-4-nitrophenol, 1-(2-hydroxyethoxy)-3-methylamino-4-nitrobenzene, 2,3-(dihydroxypropoxy)-3-methylamino-4-nitrobenzene, 3-[(2-aminoethyl)amino]-1-methoxy-4-nitrobenzene hydrochloride (HC Yellow 9), 1-chloro-2,4-bis[(2-hydroxyethyl)amino]-5-nitrobenzene (HC Yellow 10), 2-[(2-hydroxyethyl)amino]-5-nitrophenol (HC Yellow 11), 1-[(T-ureidoethyl)amino]-4-nitrobenzene, 1-amino-4-[(2-aminoethyl)amino]-5-methyl-2-nitrobenzene, 4-[(2-hydroxyethyl)amino]-3-nitro-1-methylbenzene, 1-chloro-4-[(2-hydroxyethyl)amino]-3-nitrobenzene (HC Yellow 12), 4-[(2-hydroxyethyl)amino]-3-nitro-1-trifluoromethylbenzene (HC Yellow 13).

Suitable quinone dyes are in particular 1-[(2-hydroxyethyl)amino]-4-methylamino-9,10-anthraquinone (C.l. 61505, Disperse Blue 3), mixtures of 1,4-bis[(2-hydroxyethyl)amino]anthra-9,10-quinone with 1-[(2-hydroxyethyl)amino]-4-[(3-hydroxypropyl)amino]anthra-9,10-quinone and 1,4-bis[(3-hydroxypropyl)amino]anthra-9,10-quinone (Disperse Blue 377), 1,4-diamino-9,10-anthraquinone (C.l. 61100, Disperse Violet 1), 1-amino-4-(methylamino)-9,10-anthraquinone (C.l. 61105, Disperse Violet 4, Solvent Violet No. 12), 2-hydroxy-1,4-naphthoquinone (Lawsone, C.l. 75480, Natural Orange 6), 1,4-bis[(2,3-dihydroxypropyl)amino]-9,10-anthracenedione (HC Blue 14).

Suitable neutral azo dyes are in particular 1-[di(2-hydroxyethyl)amino]-3-methyl-4-[(4-nitrophenyl)azo]benzene (C.l. 11210, Disperse Red 17), 1-[di(2-hydroxyethyl)amino]-4-[(4-nitrophenyl)azo]benzene (Disperse Black 9), 4-[(4-aminophenyl)azo]-1-[di(2-hydroxyethyl)amino]-3-methylbenzene (HC Yellow 7), 2,6-diamino-3-[(pyridin-3-yl)azo]pyridine, 4-[(4-nitrophenyl)azo]aniline (C.l. 11005; Disperse Orange 3).

Compositions B and/or C preferably contain the substantive dyes in an amount from 0.01 to 20 wt. %, relative to the total weight of composition B and/or C.

The agents according to the invention can furthermore also contain naturally occurring dyes such as for example indigo (Indigofera tinctoria), red henna (Lawsonia inermis), neutral henna or black henna. Further preferred natural dyes are contained for example in chamomile flowers, sandalwood, black tea, alder buckthorn bark, sage, logwood, madder root, catechu, lotus and alkanet root.

In a third preferred embodiment a bleaching agent, preferably a bleaching powder, is used as composition B. To produce the bleaching effect these bleaching agents preferably contain so-called boosters. These are generally solid peroxo compounds, which are not addition products of hydrogen peroxide with other components. In principle there are no restrictions governing the selection of these peroxo compounds; conventional peroxo compounds known to the person skilled in the art are for example ammonium peroxodisulfate, potassium peroxodisulfate, sodium peroxodisulfate, ammonium persulfate, potassium persulfate, sodium persulfate, potassium peroxodiphosphate, percarbonates such as magnesium percarbonate and peroxides such as barium peroxide. Of these peroxo compounds, which can also be used in combination, the inorganic compounds are preferred according to the invention. The peroxodisulfates, in particular ammonium peroxodisulfate, are particularly preferred.

The peroxo compounds are preferably contained in the bleaching agents used according to the invention as composition B in amounts from 2 to 50 wt. %, in particular in amounts from 10 to 35 wt. %. Methods that are preferred according to the invention have the characterizing feature that composition B contains at least one oxidizing agent, preferably 5.0 to 50 wt. %, preferably 10 to 45 wt. %, particularly preferably 15 to 40 wt. % and in particular 20 to 35 wt. % of persulfate, relative in each case to the total weight of composition B.

As a further important component the bleaching agents used according to the invention contain an alkalizing agent, which serves to establish the alkaline pH of the application mixture. The conventional alkalizing agents likewise known to the person skilled in the art for bleaching agents can be used according to the invention, such as ammonium, alkali metal and alkaline-earth metal hydroxides, carbonates, hydrogen carbonates, hydroxycarbonates, silicates, in particular metasilicates, and alkali phosphates. In a preferred embodiment the bleaching agents according to the invention contain at least two different alkalizing agents. Mixtures of a hydroxycarbonate and a metasilicate, for example, can be preferred here.

The proportion by weight of alkalizing agent in the total weight of the bleaching agent used as composition B is preferably 5 to 50 wt. %, preferably 10 to 45 wt. % and in particular 12 to 40 wt. %.

If a bleaching agent is used as composition B, it is preferably in powder form, wherein generally a component to dedust the finely powdered formulation is additionally added. Such deducting agents are conventionally oils, liquid waxes, ether derivatives, but also solvents that are liquid at 25° C., selected from the group of hydrocarbons, alcohols, esters and ketones, such as for example 3-methoxybutanol, benzyl alcohol, 1,2-propanediol, hexanol, cyclohexanone, propylene carbonate and ethyl diglycol.

Composition B can contain a thickening agent to adjust the viscosity, wherein in particular solid compositions B, in particular solid compositions B containing bleaching agents, preferably contain 0.5 to 20 wt. %, preferably 1.0 to 15 wt. %, particularly preferably 1.5 to 10 wt % of xanthan gum and/or carboxy cellulose.

The coloring agents produced according to the invention or the compositions A, B and C used to produce them can contain further active agents, auxiliary substances and additives, such as for example
non-ionic polymers such as for example vinyl pyrrolidone/vinyl acrylate copolymers, polyvinyl pyrrolidone and vinyl pyrrolidone/vinyl acetate copolymers and polysiloxanes,
cationic polymers such as quaternized cellulose ethers, polysiloxanes having quaternary groups, dimethyldiallylammonium chloride polymers, acrylamide-dimethyldiallylammonium chloride copolymers, diethylsulfate-quaternized dimethylaminoethyl methacrylate-vinyl pyrrolidone copolymers, vinyl pyrrolidone-imidazolinium methochloride copolymers and quaternized polyvinyl alcohol,
zwitterionic and amphoteric polymers such as for example acrylamidopropyl trimethylammonium chloride/acrylate copolymers and octylacrylamide/methyl methacrylate/tert-butyl aminoethyl methacrylate/2-hydroxypropyl methacrylate copolymers,
anionic polymers such as for example polyacrylic acids, crosslinked polyacrylic acids, vinyl acetate/crotonic acid copolymers, vinyl pyrrolidone/vinyl acrylate copolymers, vinyl acetate/butyl maleate/isobornyl acrylate copolymers, methyl vinyl ether/maleic anhydride copolymers and acrylic acid/ethyl acrylate/N-tert-butyl acrylamide terpolymers,
thickening agents such as agar-agar, guar gum, alginates, xanthan gum, gum arabic, karaya gum, carob seed meal, linseed gums, dextrans, cellulose derivatives, for example methyl cellulose, hydroxyalkyl cellulose and carboxymethyl cellulose, starch fractions and derivatives such as amylose, amylopectin and dextrins, clays such as for example bentonite or fully synthetic hydrocolloids such as for example polyvinyl alcohol,
texturizing agents such as maleic acid and lactic acid,
perfume oils, dimethyl isosorbide and cyclodextrins,
solvents and solubilizers such as ethanol, isopropanol, ethylene glycol, propylene glycol, glycerol and diethylene glycol,
quaternized amines such as methyl-1-alkylamidoethyl-2-alkylimidazolinium methosulfate,
defoaming agents such as silicones,
dyes to color the agent,
substances to adjust the pH, such as for example conventional acids, in particular edible acids, and bases,
cholesterol,
consistency modifiers such as sugar esters, polyol esters or polyol alkyl ethers,
fats and waxes such as spermaceti wax, beeswax, montan wax and paraffins,
fatty acid alkanol amides,
complexing agents such as ethylene diamine tetraacetic acid (EDTA), nitroacetic acid (NTA), β-alanine diacetic acid and phosphonic acids,
swelling and penetrating substances such as glycerol, propylene glycol monoethyl ether, carbonates, hydrogen carbonates, guanidines, ureas as well as primary, secondary and tertiary phosphates,
opacifiers such as latex, styrene/polyvinylpyrrolidone (PVP) and styrene/acrylamide copolymers,
pearlescent agents such as ethylene glycol mono- and distearate as well as polyethylene glycol (PEG)-3 distearate,
preservatives,
stabilizing agents for hydrogen peroxide and other oxidizing agents,
propellants such as propane-butane mixtures, nitrous oxide (N₂O), dimethyl ether, carbon dioxide (CO₂) and air,
antioxidants.

The care agent contained preferably in composition C is preferably an active agent from the group of
hair-conditioning compounds such as phospholipids, for example soy lecithin, egg lecithin and cephalins,
protein hydrolysates, in particular elastin, collagen, keratin, milk protein, soy protein and wheat protein hydrolysates, condensation products thereof with fatty acids and quaternized protein hydrolysates,
active agents to improve the fiber structure, in particular mono-, di- and oligosaccharides such as for example glucose, galactose, fructose, fruit sugar and lactose,
anti-dandruff active agents such as piroctone olamine, zinc omadine and climbazole,
light stabilizers, in particular derivatized benzophenones, cinnamic acid derivatives and triazines,
active agents such as allantoin, pyrrolidone carboxylic acids and salts thereof and bisabolol,
vitamins, provitamins and vitamin precursors, in particular those from groups A, B₃, B₅, B₆, C, E, F and H,
plant extracts such as the extracts from green tea, oak bark, stinging nettle, witch hazel, hops, chamomile, burdock, horsetail, whitethorn, lime blossom, almond, aloe vera, pine, horse chestnut, sandalwood, juniper, coconut, mango, apricot, lemon, wheat, kiwi, melon, orange, grapefruit, sage, rosemary, birch, mallow, lady's smock, wild thyme, yarrow, thyme, melissa, restharrow, coltsfoot, marshmallow, meristem, ginseng and ginger root.

Some of the combinations of compositions A, B and C that are advantageously used in the method according to the invention can be taken from the table below:

TABLE 1

| | | | |
|---|---|---|---|
| 1 | 2 | 3 | 4 |

Composition A: Amounts in wt. % relative to composition A

| | | | | |
|---|---|---|---|---|
| Oxidizing agent | 0.5 to 50 | 1.0 to 20 | 2.5 to 16 | 5.0 to 14 |
| Misc | to 100 | to 100 | to 100 | to 100 |

Composition B: Amounts in wt. % relative to composition B

| | | | | |
|---|---|---|---|---|
| Oxidation dye | 0.005 to 20 | 0.01 to 10 | 0.1 to 5.0 | 0.1 to 3.0 |
| precursor | | | | |
| Misc | to 100 | to 100 | to 100 | to 100 |

Composition C: Amounts in wt. % relative to composition C

| | | | | |
|---|---|---|---|---|
| Substantive dye | 0.01 to 20 | 0.1 to 15 | 0.2 to 10 | 0.5 to 5.0 |
| Misc | to 100 | to 100 | to 100 | to 100 |

TABLE 2

| | | | |
|---|---|---|---|
| 5 | 6 | 7 | 8 |

Composition A: Amounts in wt. % relative to composition A

| | | | | |
|---|---|---|---|---|
| Oxidizing agent | 0.5 to 50 | 1.0 to 20 | 2.5 to 16 | 5.0 to 14 |
| Misc | to 100 | to 100 | to 100 | to 100 |

Composition B: Amounts in wt. % relative to composition B

| | | | | |
|---|---|---|---|---|
| Oxidation dye | 0.005 to 20 | 0.01 to 10 | 0.1 to 5.0 | 0.1 to 3.0 |
| precursor | | | | |
| Misc | to 100 | to 100 | to 100 | to 100 |

Composition C: Amounts in wt. % relative to composition C

| | | | | |
|---|---|---|---|---|
| Care agent | 0.01 to 20 | 0.1 to 15 | 0.2 to 10 | 0.5 to 5.0 |
| Misc | to 100 | to 100 | to 100 | to 100 |

TABLE 3

| | | | |
|---|---|---|---|
| 9 | 10 | 11 | 12 |

Composition A: Amounts in wt. % relative to composition A

| | | | | |
|---|---|---|---|---|
| Hydrogen peroxide | 0.5 to 50 | 1.0 to 20 | 2.5 to 16 | 5.0 to 14 |
| Misc | to 100 | to 100 | to 100 | to 100 |

Composition B: Amounts in wt. % relative to composition B

| | | | | |
|---|---|---|---|---|
| Oxidation dye | 0.005 to 20 | 0.01 to 10 | 0.1 to 5.0 | 0.1 to 3.0 |
| precursor | | | | |
| Misc | to 100 | to 100 | to 100 | to 100 |

Composition C: Amounts in wt. % relative to composition C

| | | | | |
|---|---|---|---|---|
| Substantive dye | 0.01 to 20 | 0.1 to 15 | 0.2 to 10 | 0.5 to 5.0 |
| Misc | to 100 | to 100 | to 100 | to 100 |

TABLE 4

| | | | |
|---|---|---|---|
| 13 | 14 | 15 | 16 |

Composition A: Amounts in wt. % relative to composition A

| | | | | |
|---|---|---|---|---|
| Hydrogen peroxide | 0.5 to 50 | 1.0 to 20 | 2.5 to 16 | 5.0 to 14 |
| Misc | to 100 | to 100 | to 100 | to 100 |

Composition B: Amounts in wt. % relative to composition B

| | | | | |
|---|---|---|---|---|
| Oxidation dye | 0.005 to 20 | 0.01 to 10 | 0.1 to 5.0 | 0.1 to 3.0 |
| precursor | | | | |
| Misc | to 100 | to 100 | to 100 | to 100 |

Composition C: Amounts in wt. % relative to composition C

| | | | | |
|---|---|---|---|---|
| Care agent | 0.01 to 20 | 0.1 to 15 | 0.2 to 10 | 0.5 to 5.0 |
| Misc | to 100 | to 100 | to 100 | to 100 |

As stated in the introduction, the method according to the invention is used in particular to produce coloring agents for human hair. Methods that are preferred according to the invention therefore have the characterizing feature that the coloring agent for keratin fibers is applied to keratin fibers, preferably human hair. Application of the coloring agent takes place preferably immediately, i.e. within a period of less than 30 minutes, preferably less than 15 minutes, particularly preferably less than 10 minutes and in particular less than 5 minutes after the mixing of compositions A, B and C.

Methods for producing a coloring agent for keratin fibers from a first composition A, a second composition B and a third composition C are particularly preferred in which
the first composition A, containing relative to its total weight 0 to 50 wt. %, preferably 0.5 to 50 wt % of an oxidizing agent, is directed from a container A by means of a filling device via an inlet
to a second container B, containing the second composition B, wherein composition B contains 0.005 to 20 wt. %, relative to its total weight, of an oxidation dye precursor,
wherein container B, through the introduction of composition A and/or the influence of the filling device, forms at least one outlet, from which a mixture of compositions A and B emerges, and the mixture of compositions A and B
is introduced into a third container C, containing the third composition C, wherein composition C contains 0.01 to 20 wt. %, relative to its total weight, of a substantive dye.

Methods for producing a coloring agent for keratin fibers from a first composition A, a second composition B and a third composition C are preferred moreover in which
the first composition A, containing relative to its total weight 0 to 50 wt. %, preferably 0.5 to 50 wt. % of an oxidizing agent, is directed from a container A by means of a filling device via an inlet
to a second container B containing the second composition B, wherein composition B contains 0.005 to 20 wt. %, relative to its total weight, of an oxidation dye precursor,
wherein container B, through the introduction of composition A and/or the influence of the filling device, forms at least one outlet, from which a mixture of compositions A and B emerges, and the mixture of compositions A and B
is introduced into a third container C containing the third composition C, wherein composition C contains 0.01 to 20 wt. %, relative to its total weight, of a care agent.

The present application also provides a container encompassing
a container wall closing the container to the outside
a break line integrated into the container wall
a composition encompassing at least one care agent for keratinic fibers contained in the container.

The present application additionally provides a container encompassing
a container wall closing the container to the outside
a break line integrated into the container wall
a static mixer integrated into the container
a composition encompassing at least one care agent for keratinic fibers contained in the container.

The present application furthermore provides a container encompassing
a container wall closing the container to the outside
a spike which is suitable for piercing the container wall under the action of a force on the spike and/or the container wall
a composition encompassing at least one care agent for keratinic fibers contained in the container.

Moreover, a container encompassing
a container wall closing the container to the outside
a spike which is suitable for piercing the container wall under the action of a force on the spike and/or the container wall
a static mixer integrated into the container
a composition encompassing at least one care agent for keratinic fibers contained in the container
   is claimed.

The proportion by weight of the care agent for keratinic fibers in the total weight of the compositions contained in the aforementioned containers is preferably 0.005 to 20 wt. %.

For the avoidance of repetition, reference is made to the aforementioned statements with regard to the chemical nature of the care agent and of the other optional ingredients in the container.

The volume of the aforementioned containers is preferably 5 to 100 ml, preferably 10 to 80 ml and in particular 20 to 60 ml.

Preferred containers have a cylindrical enveloping surface, a flat top face and a flat or conically executed bottom face on the opposite side from this top face. Particularly preferred containers have a flange, to which a heat-sealing film closing the container is attached. Such a flange makes it easier for example to secure the container by means of a screw-type, adhesive, latching, snap-action or clamping mechanism in the device used to perform the method according to the invention.

The aforementioned containers are preferably manufactured from chemically inert materials. The group of these materials includes for example aluminum or plastics such as polypropylene.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for producing a coloring agent for keratin fibers from a first composition A, a second composition B and a third composition C, in which
the first composition A is directed from a container A
by means of a filling device
via an inlet
to a second container B containing the second composition B and/or
to a third container C containing the third composition C,
wherein composition A is introduced into container B and/or into container C, and container B and/or container C, through the introduction of composition A and/or the influence of the filling device, forms at least one outlet, from which a mixture of compositions A and B and/or a mixture of compositions A and C emerges.

2. The method of claim 1, wherein composition A is introduced into container B and into container C, and container B and container C, through the introduction of composition A and/or the influence of the filling device, form at least one outlet, from which a mixture of compositions A and B or a mixture of compositions A and C emerges, and the mixture of compositions A and B and the mixture of compositions A and C are subsequently combined to form a coloring agent for keratin fibers.

3. The method of claim 1, wherein composition A is introduced into container B, and container B, through the introduction of composition A and/or the influence of the filling device, forms at least one outlet, from which a mixture of compositions A and B emerges, which mixture is subsequently introduced into container C containing composition C with formation of the coloring agent for keratin fibers.

4. The method of claim 1, wherein composition A is introduced into container C, and container C, through the introduction of composition A and/or the influence of the filling device, forms at least one outlet, from which a mixture of compositions A and C emerges, which mixture is subsequently introduced into container B containing composition B with formation of the coloring agent for keratin fibers.

5. The method of claim 1, wherein composition A is introduced into container B and/or into container C at a pressure above 1.1 bar.

6. The method of claim 5, wherein the pressure is 10 to 20 bar.

7. The method of claim 1, wherein composition A contains an oxidizing agent.

8. The method of claim 7, wherein the oxidizing agent is hydrogen peroxide (calculated as 100% H₂O₂), relative to the total weight of composition A, in an amount of 0.5 to 50 wt. %.

9. The method of claim 8, wherein the hydrogen peroxide is present in an amount of 5.0 to 14 wt. %.

10. The method of claim 1, wherein composition B contains at least one oxidation dye precursor or at least one substantive dye.

11. The method of claim 1, wherein composition B contains at least one oxidizing agent.

12. The method of claim 1, wherein the oxidizing agent is persulfate present in an amount of 5.0 to 50 wt. % relative to the total weight of composition B.

13. The method of claim 12, wherein the persulfate is present in an amount of 20 to 35 wt. %.

14. The method of claim 1, wherein composition C contains at least one care agent or at least one oxidation dye precursor or at least one substantive dye.

15. The method of claim 1, wherein the coloring agent for keratin fibers is applied to hair.
